(19) United States
(12) Patent Application Publication
(10) Pub. No.: US 2005/0262123 A1
(43) Pub. Date: Nov. 24, 2005

(54) Data communication terminal unit

(75) Inventor: Noboru Hirano, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SES JAPAN CO., LTD., Tokyo (JP)

(21) Appl. No.: 10/524,756

(22) PCT Filed: Nov. 18, 2002
(86) PCT No.: PCT/JP02/11994

§ 371 Date: Feb. 11, 2005

(30) Foreign Application Priority Data
Aug. 13, 2002 (JP) 2002-235844

(51) Int. Cl. G06F 7/00

(52) U.S. Cl. 707/101

(57) ABSTRACT

Data communications terminals efficiently transfer image and audio data across a data circuit without being affected by the degree of congestion of the data circuit by altering, in accordance with the degree of congestion, the image and sound qualities and/or the transfer rate of each frame while maintaining minimum preferred qualities of the image and audio data. To do this, a transmitting terminal (2) and a receiving terminal (4) have the same data transfer capabilities. The data transfer capability include a transmission capability that enables regulation of the image and sound qualities and/or frame rate of each data frame to be transmitted from the transmitting terminal (2) to the receiving terminal (4) based on whether the measured data transmission time required to transmit a respective data frame has increased or not. The data transfer capability also includes a reception capability that enables measurement of data reception time required for the receiving terminal (4) to receive a respective data frame transmitted from the transmitting terminal (2) and returns the measured data reception times to the transmitting terminal (2). The transmitting terminal (2) regulates the image and sound qualities and/or frame rate of a subsequent data frame to be sent based on the data transmission time and/or the data reception time.

### FIELD OF THE INVENTION

The invention relates to a data communications terminal capable of transferring frame data across a data circuit with regulated image and sound qualities and/or at a regulated frame rate in accordance with the degree of congestion (or availability) of the data circuit.

### PRIOR ART

There have been disclosed several data communications terminals. For example, Japanese Patent Application Laid Open 2002-34024 discloses a data communications terminal that changes setup conditions of the terminal in accordance with the degree of congestion of a data circuit. Japanese Patent Application Laid Open 2002-55902 discloses a communications terminal having a capability to determine whether the data circuit in use is congested or not by monitoring data transfer time and terminate the data transfer when the data transfer time is larger than a preset period of time. Japanese Patent Application Laid Open 2000-295272 discloses another data communications terminal having a capability to send a test file associated with an original data file across a data circuit to see if the data transfer time exceeds a predetermined time and, if it does, determine that the data circuit is congested. When the data circuit is congested, the data compression ratio of the original image data is increased or the frame rate is reduced. It is noted that these data communications terminals are all directed to data transfers of image data only, not to image data and audio data, to which the present invention is directed. Note further that prior art mechanisms of determining the degree of congestion rely on the comparison of data transfer time with a predetermined reference time, and that the prior art cannot precisely determine such time varying congestion of a data circuit or cannot transfer image and audio data efficiently with adequate image and sound qualities and/or at an adequate frame rate in accordance with the congestion of the data circuit.

It is, therefore, an object of the invention to overcome these problems mentioned above by providing simple means for efficiently transferring data frames containing both image and audio data while maintaining at least minimum levels of image and sound qualities without waiting for a free data circuit by measuring the degree of congestion (or availability) of the data circuit on the real time basis and varying the image and sound qualities and/or the frame rate of data transfer in accordance with the congestion.

### DISCLOSURE OF INVENTION

(1) The invention is a data communications terminal for sequentially transferring frame data to and from another data communications terminal via a data circuit in units of data frames with each data frame amounting to one still picture containing compressed image data of variable length and compressed audio data of variable length, the data communications terminal characterized by a data transmission function capable of:
transmitting a multiplicity of leading data frames with predetermined image and sound qualities and/or a predetermined frame rate;
determining the degree of congestion of the data circuit based on the data transmission time to transmit a data frame that precedes the current data frame by at least one data frame;
making a determination that the degree of congestion of the data circuit has increased (vacancy of the data circuit has decreased) when the data transmission time is increasing, thereby transmitting the next data frame with reduced picture and sound qualities and/or a reduced frame rate; and
making a determination that the degree of congestion of the data circuit has decreased (vacancy of the data circuit has increased) when the data transmission time is decreasing, thereby transmitting the next data frame with an increased picture and sound qualities and/or a reduced frame rate.

(2) The invention can be a data communications terminal for sequentially transferring frame data to and from another data communications terminal via a data circuit in units of data frames with each data frame amounting to one still picture containing compressed image data of variable length and compressed audio data of variable length, the data communications terminal characterized by a data transmission function capable of:
transmitting a multiplicity of leading data frames with predetermined image and sound qualities and/or a predetermined frame rate;
determining the degree of congestion of the data circuit from the data reception time for the communications terminal receiving frame data to receive the data frame that precede the current data frame by at least one data frame;
making a determination that the degree of congestion of the data circuit has increased (vacancy of the data circuit has decreased) when the data reception time is increasing, thereby transmitting the next data frame with reduced image and sound qualities and/or a reduced frame rate; and
making a determination that the congestion of the data circuit has decreased (vacancy of the data circuit has increased) when the data reception time is decreasing, thereby transmitting the next data frame with increased image and sound qualities and/or an increased frame rate.

(3) The invention can be a data communications terminal for sequentially transferring frame data to and from another data communications terminal via a data circuit in units of data frames with each data frame amounting to one still picture containing compressed image data of variable length and compressed audio data of variable length, the data communications terminal characterized by data transmission functions capable of:
transmitting a multiplicity of leading data frames with predetermined image and sound qualities and/or a predetermined frame rate;
calculating a ratio (data reception time)/(data transmission time) from the data transmission time for the data communications terminal transmitting frame data to transmit respective data frames that precede the current data frame by at lease one data frame and the data reception time for the data communicatons terminal receiving frame data to receive respective data frames that precede the current data frame by at least one data frame;
determining the degree of congestion of the data circuit from the (data reception time)/(data transmission time);
making a determination that the degree of the data circuit has increased (vacancy of the data circuit has decreased) when the ratio (data reception time)/(data transmission time) is increasing, thereby transmitting the next data frame with reduced image and sound qualities and/or a reduced frame rate; and
making a determination that the degree of congestion of the data circuit has decreased (vacancy of the data circuit has increased) when the ratio (data reception time)/(data transmission time) is decreasing, thereby transmitting the next data frame with increased image and sound qualities and/or an increased frame rate.

(4) The invention can be the data communications terminal according to any one of (1), (2), and (3) above, is characterized in that the communications terminal receiving frame data has a data reception time measurement and data transmission function capable of measuring data reception time to receive respective data frames that are transmitted in sequence from a data communications terminal and transmitting the measured data reception time to the data transmitting terminal.

(5) The invention can be the data communications terminal according to any one of (1), (2), and (3) above, characterized in that the data transmission time is the time interval from the beginning of the transmission of data frame that precedes the current data frame by at least one frame and the end of the transmission by the data communications terminal transmitting frame data.

(6) The invention can be the data communications terminal according to any one of (2), (3), and (4) above, characterized in that the data reception time is the time interval from the beginning of the reception of data frame that precedes the current data frame by at least one frame and the end of the reception by the terminal receiving frame data.

(7) The invention can be the data communications terminal according to (1) or (5) above, characterized in that the data communications terminal is adapted to:
make a determination that the degree of congestion of the data circuit has increased (vacancy of the data circuit has decreased) when the data transmission time is increasing, thereby transmitting the next data frame with an increased data compression rate, a reduced picture size, and/or a reduced frame rate; and
make a determination that the degree of congestion of the data circuit has decreased (vacancy of the data circuit has increased) when the data transmission time is decreasing, thereby transmitting the next data frame with a reduced data compression rate, an increased picture size, and/or an increased frame rate.

(8) The invention can be the data communications terminal according to (2) or (6) above, characterized in that the data communications terminal is adapted to:
make a determination that the degree of congestion of the data circuit has increased (vacancy of the data circuit has decreased) when the data reception time is increasing, thereby transmitting the next data frame with an increased data compression rate, a reduced picture size, and/or a reduced frame rate; and
make a determination that the degree of congestion of the data circuit has decreased (vacancy of the data circuit has increased) when the data reception time is decreasing, thereby transmitting the next data frame with a reduced data compression rate, an increased picture size, and/or an increased frame rate.

(9) The invention can be the data communications terminal according to (3) above, characterized in that the data communications terminal is adapted to:
make a determination that the degree of congestion of the data circuit has increased (vacancy of the data circuit has decreased) when the ratio (data reception time)/(data transmission time) is increasing, thereby transmitting the next data frame with an increased data compression rate, a reduced picture size, and/or a reduced frame rate; and
make a determination that the degree of congestion of the data circuit has decreased (vacancy of the data circuit has increased) when the ratio (data reception time)/(data transmission time) is decreasing, thereby transmitting the next data frame with a reduced data compression rate, an increased picture size, and/or an increased frame rate.

(10) The invention can be the data communications terminal according to any one of (1), (2), and (3) above, characterized in that the data communications terminal prioritizes the sound quality over the frame rate of frame data to be transmitted when controlling the picture quality, sound quality and/or frame rate thereof in accordance with the degree of congestion of the data circuit.

(11) The invention can be the data communications terminal according to any one of (1), (2), and (3) above, characterized in that the data communications terminal is adapted to maintain a constant quality of the frame data to be transmitted such that, when reducing the picture and sound qualities and/or frame rate thereof, the picture and sound reproduced from the frame data are recognizable.

(12) The invention can be the data communications terminal according to any one of (1), (2), and (3) above, characterized in that the picture quality is given by the data compression rate and picture size (numbers of pixels in vertical and horizontal directions) of relevant picture data, and the sound quality is given by the data compression rate of relevant audio data.

### BRIEF DESCRIPTION OF THE DRAWINGS

The invention will now be described in detail by way of example with reference to accompanying drawings, in which

FIG. 1 is a block diagram representation of a data transfer system for transferring data from a data communications terminal of the invention serving as a transmitting terminal to another communications terminal of the invention serving as a receiving terminal via a data circuit, adapted to determine the degree of congestion of the data circuit from the data transmission time measured by the transmitting terminal.

FIG. 2 is a block diagram representation of a data transfer system for transferring data from a data communications terminal of the invention serving as a transmitting terminal to another communications terminal of the invention serving as a receiving terminal via a data circuit, adapted to determine the degree of congestion of the data circuit from data reception time measured by the receiving terminal (which is a time for the receiving terminal to receive 1 data frame).

FIG. 3 a block diagram representation of a data transfer system for transferring data from a data communications terminal of the invention serving as a transmitting terminal to another communications terminal of the invention serving as a receiving terminal via a data circuit, adapted to determine the degree of congestion of the data circuit from the data transmission time measured by the transmitting terminal and the data reception time measured by the receiving terminal.

FIG. 4 (a) is a data format of a data frame for use in the data transfer by a data communications terminal of the invention. FIG. 4 (b) shows operations of a data communications terminal for measuring the degree of congestion of a data circuit, calculating an optimum image quality and an optimum frame rate based on the congestion of the data circuit, and transmitting frame data at the calculated image quality and frame rate.

FIG. 5 shows a block diagram showing details of a data communications terminal (serving as a transmitting terminal).

FIG. 6 shows a block diagram showing details of a data communications terminal (serving as a receiving terminal).

FIG. 7 is a flowchart of calculating/regulating image quality and frame rate from data transmission time for 1 data frame by means of an image quality and frame rate calculation unit 2I according to the invention.

FIG. 8 is a flowchart of calculating/regulating image quality and frame rate from data reception time for 1 frame by means of the image quality and frame rate calculation unit 2I according to the invention.

FIG. 9 is a flowchart of calculating/regulating image quality and frame rate from data transmission time for 1 frame and data reception time for 1 frame by means of the image quality and frame rate calculation unit 2I according to the invention.

### MODE FOR CARRYING OUT THE INVENTION

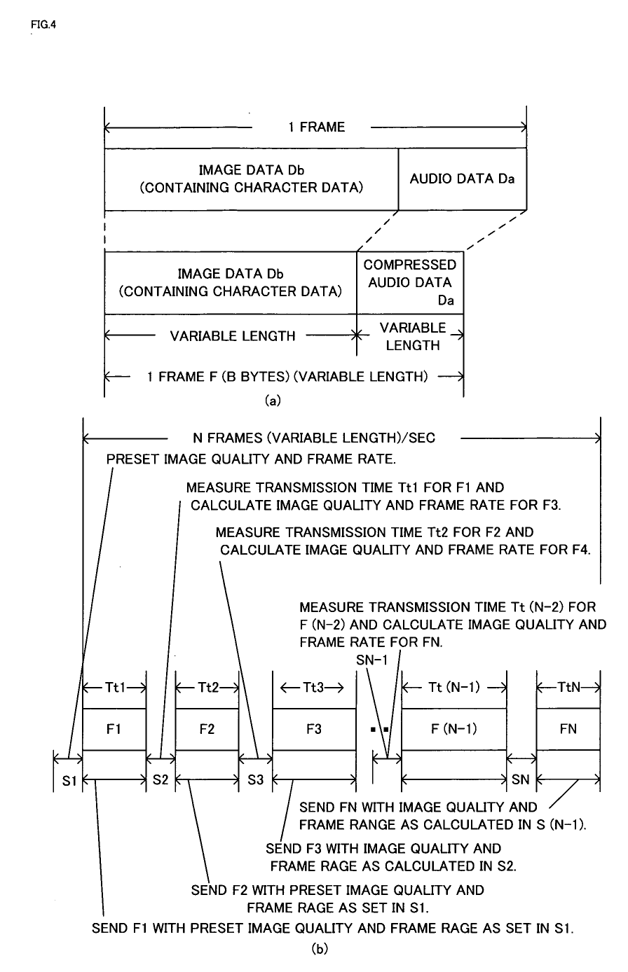

The invention pertains to a data communications for sequentially transferring data in units of data frames from a data communications terminal of the invention serving as a transmitting terminal to another data communications terminal of the invention serving as a receiving terminal across a data circuit, with each data frame amounting to one still picture image data of variable length and compressed audio data of variable length. The above described compressed data frame F of variable length consists of compressed image data Db of variable length and compressed audio data Da of variable length, as shown in FIG. 4(a). The image data Db and audio data are obtained by compressing uncompressed data frame F′ of variable length consisting of image data Db′ and audio data Da′ in a data communications terminal using proper compression methods suitable for the respective data.

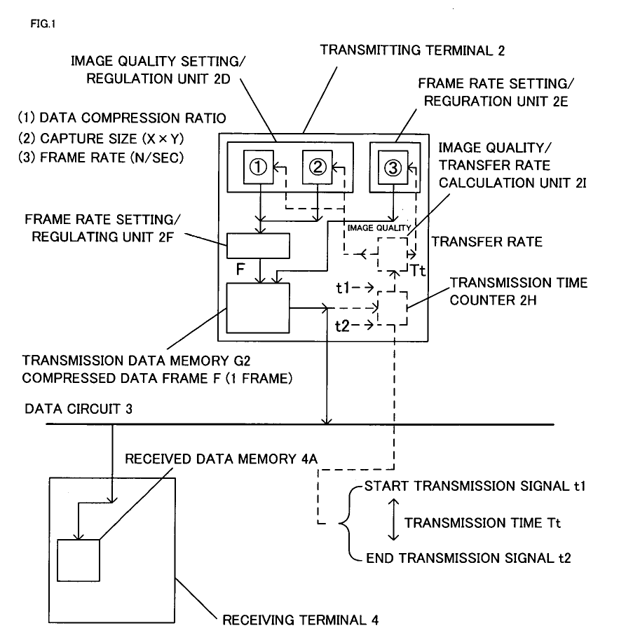

As shown in FIGS. 1-3, two identical data communications terminals of the invention, one serving as a transmitting terminal 2 and another as a receiving terminal 4, are connected via a data circuit 3. Each of these terminals has two fundamental capabilities, data transmission capability A and data reception capability B.

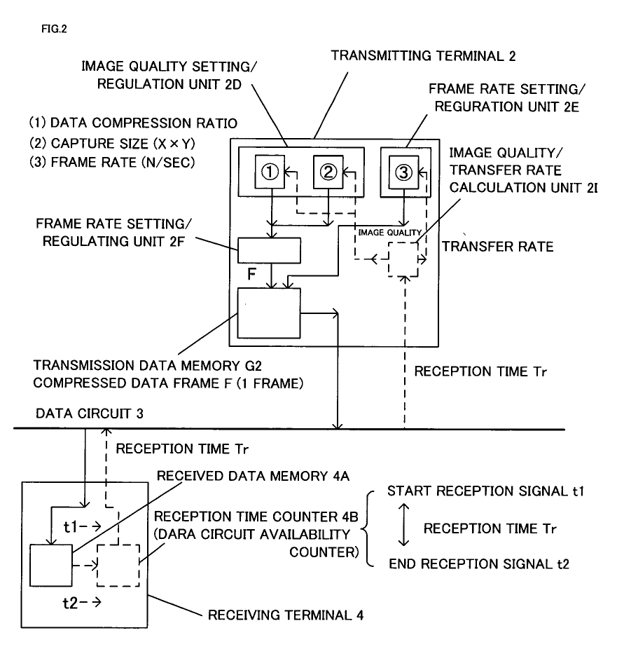

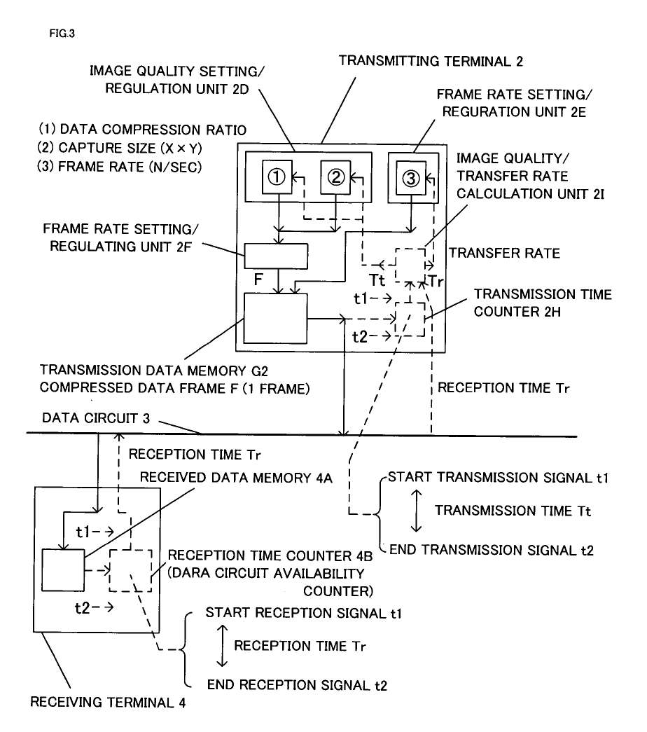

Based on the data transmission time Tt measured by the data communications terminal acting as a transmitting terminal 2 as shown in FIG. 1 or data reception time Tr measured by the data communications terminal acting as a receiving terminal 4 as shown in FIG. 2, and based on the data transmission time Tt and data reception time Tr as shown in FIG. 3, the transmission capability A enables the terminal to determine whether data transmission time and/or data reception time are/is increasing for the current data frame and to transmit a data frame with regulated image and audio qualities and/or at a frame rate based on the determination.

The reception capability B enables the data communications terminal (receiving terminal 4) to measure data reception time Tr for a data frame received from the transmitting terminal 2 and stored in a received data memory 4A by means of a reception time counter 4B, and send the measured data reception time Tr to the transmitting terminal 2 using the transmission capability A of the receiving terminal 4 as shown in FIGS. 2, 3, and 6.

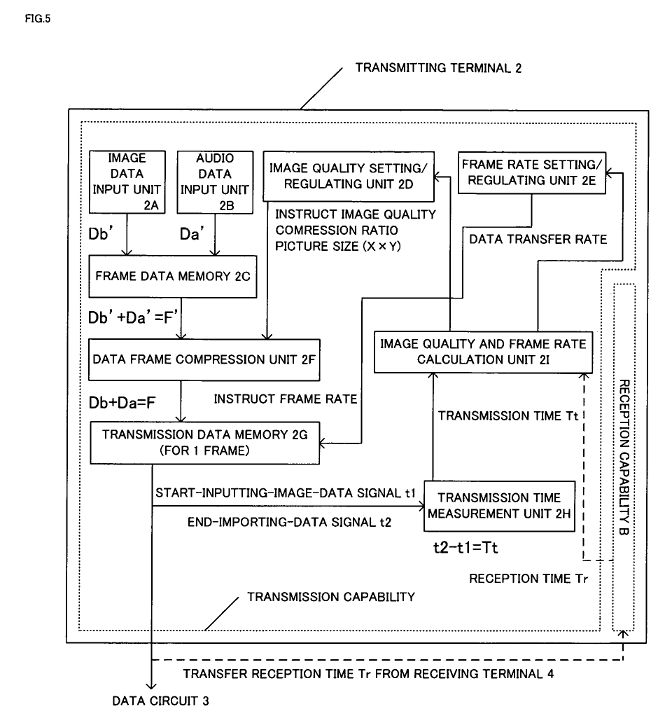

Details of the transmission capability A of the data communications terminal serving as a transmitting terminal 2 are as follows. Image data Db′ entering an image information input unit 2A and audio data Da′ entering an audio data input unit 2B are integrated into a single data frame F′ and stored in a frame data memory 2C, as shown in FIG. 5. Each uncompressed frame data F′ has a variable length. Each of the data frames F′ is compressed to data frame F consisting of compressed image data Db′ and compressed audio data Da′ by means of a data frame compression unit 2F based on image and sound quality data (specifying data compression ratio and picture size) prescribed by an image and sound qualities setting/regulating unit 2D. The compressed frame data F thus formed is once stored in a transmission data memory 2G, and transferred therefrom at the transfer rate (frame rate) set up by a frame rate setting/regulating unit 2E. The image and sound qualities data (specifying data compression ratio and picture size) set up by the image quality setting/regulating unit 2D and the frame rate (transfer rate) set up by the frame rate setting/regulating unit 2E are modified based on the data calculated by an image quality and frame rate calculation unit 2I in accordance with the degree of congestion of the data circuit 3.

It is noted that in regulating the image and sound qualities and frame rate, the regulation of image and sound qualities may be prioritized over the regulation of frame rate. For example, when the data circuit 3 is congested, the image and sound qualities may be dropped to a level at which the image can be recognized and the sound can be audible while maintaining a constant frame rate. The image quality is given in terms of data compression ratio of image data and picture size (or vertical and horizontal numbers of pixels). Sound quality is given in terms of data compression ratio of audio data.

The degree of congestion (or availability) of the data circuit 3 can be determined based on: (1) data transmission time Tt for sending 1 frame data stored in the transmission data memory of the transmitting terminal 2 as shown in FIG. 1; (2) data reception time Tr for storing 1 frame data in the received data memory of the receiving terminal 4 as shown in FIG. 2; and (3) data transmission time Tt and data reception time Tr, as shown in FIG. 3. Incidentally, the data transmission time Tt is defined to be the time interval between the beginning (at time t1) and the end (at time t2) of the transmission of 1 compressed data frame Fstored in the transmission data memory 2G. The data reception time Tr is defined to be the time interval between the beginning (at time t1) of the reception and the end (at time t2) of storing 1 compressed data frame F in the received data memory 4A. Although means for measuring these time intervals are necessary, calculations of the time intervals may be carried out by an instruction set of a data transmission program or of a data reception program, so that data communication terminals can be simplified in structure.

Operations of the receiving terminal 2 controlling the image and sound qualities and/or transfer rate (frame rate) of compressed data frames F will now be described in detail for an instance where the control is based on the data transmission time Tt in accordance with the first method (1) above.

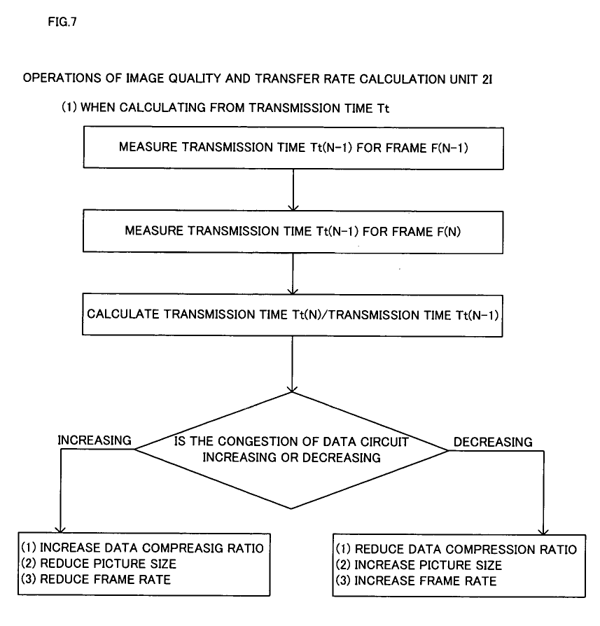

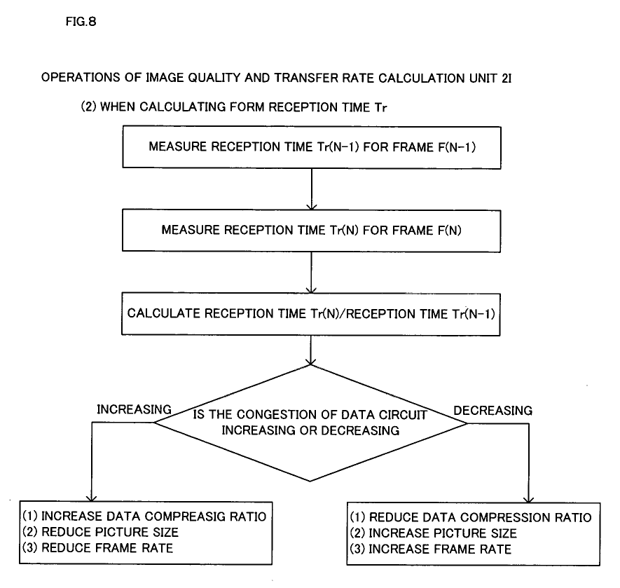

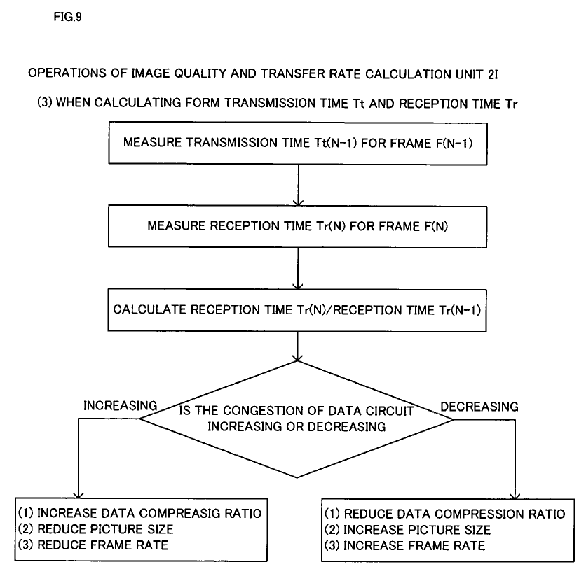

In the transmitting terminal 2 a transmission time measurement unit 2H measures data transmission time Tt by measuring the time interval between the beginning (at time t1) and the end (at time t2) of the transmission of 1 compressed data frame F stored in the transmission data memory 2G,, as shown in FIG. 1 and 5. An image and sound qualities calculation unit 2I calculates a ratio Tt(N)/Tt(N−1) of the data transmission time Tt(N) for the current frame FN to the data transmission time Tt(N−1) for the immediately preceding data frame F(N−1) and determines whether the data transmission time Tt is increasing or decreasing in accordance with the ratio being larger or smaller than 1, as shown in FIG. 7. When it is determined that the data transmission time Tt is increasing, the image quality and frame rate calculation unit 2I instructs the image quality setting/regulating unit 2D to increase the data compression ratio and decrease the screen size, and instructs the frame rate setting/regulating unit 2E to decrease the frame rate. When the data transmission time is decreasing, the image quality and frame rate calculation unit 2I instructs the image quality setting/regulating unit 2D to decrease the data compression ratio and to increase the screen size, and instructs the frame rate setting/regulating unit 2E to raise the frame rate. The procedure of the second method (2) after the determination of data reception time Tr and the procedure of the third method (3) after the determination of data transmission time Tt and data reception times Tr are the same as that of the first method (1) as shown in FIG. 8 and FIG. 9, respectively.

In the example shown in FIG. 4(b), of the frame data F1, F2 . . . (F(N−1), and FN sequentially transmitted from the transmitting terminal 2, the first and the second data frames F1 and F2, respectively, are transmitted with the image and sound qualities (i.e. data compression ratio and screen size) and at the transfer rate (frame rate) as initially set up by the image quality setting/regulating unit 2D and frame rate setting/regulating unit 2E, respectively. Subsequent data frames are each transmitted with regulated image and sound qualities and at a regulated transfer rate (frame rate) as prescribed by the image quality and frame rate calculation unit 2I. That is, each of the subsequent data frames F3, T4 . . . is transmitted with reduced image and sound qualities and/or at a reduced frame rate when a determination is made that the degree of congestion of the data circuit has increased based on the measurement of a data transmission time (Tt1, Tt2 . . . ) for a respective preceding data frame (F1, F2 . . . ), but when a determination is made that the degree of congestion of the data circuit has decreased based on the measurement, subsequent data frames are each transmitted with enhanced image and sound qualities and/or at an increased frame rate.

The first and the second data frames F1 and F2 are transmitted with the initially set image and sound qualities and at the initially set frame rate, because measurement and processing of the data transmission time Tt1 for the first data frame and calculations of optimum image and sound qualities and frame rate have not been completed by the time the second data frame F2 is transmitted. Incidentally, in the second method (2) in which the degree of congestion of the data circuit is determined from the data reception time Tr and in the third method (3) in which the congestion is determined from the data reception time Tr and the data transmission time Tt, an extra amount of time is required to send the measured data reception time Tr. Hence, the determination of the degree of congestion of the data circuit is made based on the measurements of the data transfer/reception time for a data frame that precedes the current data frame by two frames. Thus, the image and sound qualities and/or frame rate of the subsequent data frames are regulated based on this determination.

The reception capability B of a data communications terminal (serving as a receiving terminal) 4 will now be described in detail below.

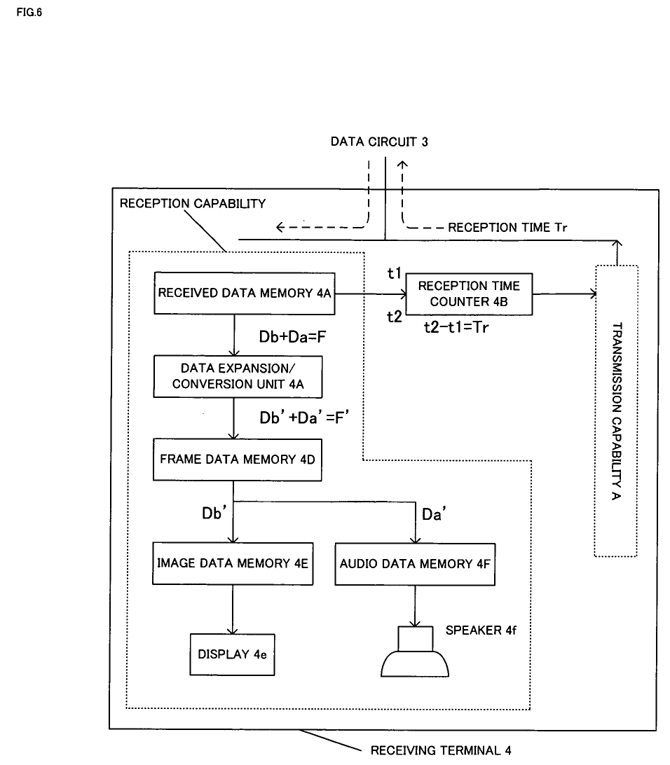

The reception capability B causes each (compressed) data frame F received from the transmitting terminal 2 to be stored in the received data memory 4A, as shown in FIG. 6. Data reception time Tr is measured by the reception time counter 4B of the receiving terminal 4 for each data frame. The measured data reception time is returned to the transmitting terminal 2 using the transmission capability A of the receiving terminal 4. Each data frame F stored in the received data memory 4A is reconverted to restore its original format by a data expansion/conversion unit 4C and stored in a frame data memory 4D, and then split up into image data Db′ and audio data Da′. An image is reproduced from the image data Db′ by an image reproduction unit and displayed on a display 4e. A sound is reproduced from the audio data Da′ by a sound reproduction unit that includes speakers.

### INDUSTRIAL APPLICABILITY

As described above, the invention may provide a structurally simple data communications terminals capable of efficiently transferring data frames containing both image and audio data via a data circuit while maintaining certain minimum levels of image and/or sound qualities without waiting for a usable data circuit. This can be done by measuring the degree of congestion (or availability) of the data circuit on the real time basis and altering the image and sound qualities and/or frame rate of a respective data frame in accordance with the degree of congestion.

1. A data communications terminal for sequentially transferring frame data to and from another data communications terminal via a data circuit in units of data frames with each data frame amounting to one still picture containing compressed image data of variable length and compressed audio data of variable length, said data communications terminal characterized by a data transmission function capable of:
transmitting a multiplicity of leading data frames with predetermined image and sound qualities and/or a predetermined frame rate;
determining the degree of congestion of said data circuit from the data transmission time to transmit a data frame that precedes the current data frame by at least one data frame;
making a determination that the degree of congestion of said data circuit has increased (vacancy of said data circuit has decreased) when said data transmission time is increasing, thereby transmitting the next data frame with reduced picture and sound qualities and/or a reduced frame rate; and
making a determination that the degree of congestion of said data circuit has decreased (vacancy of said data circuit has increased) when said data transmission time is decreasing, thereby transmitting the next data frame with an increased picture and sound qualities and/or a reduced frame rate.

2. A data communications terminal for sequentially transferring frame data to and from another data communications terminal via a data circuit in units of data frames with each data frame amounting to one still picture containing compressed image data of variable length and compressed audio data of variable length, said data communications terminal characterized by a data transmission function capable of:
transmitting a multiplicity of leading data frames with predetermined image and sound qualities and/or a predetermined frame rate;
determining the degree of congestion of said data circuit from the data reception time for the communications terminal receiving frame data to receive the data frame that precede the current data frame by at least one data frame;
making a determination that the degree of congestion of said data circuit has increased (vacancy of said data circuit has decreased) when said data reception time is increasing, thereby transmitting the next data frame with reduced image and sound qualities and/or a reduced frame rate; and
making a determination that the congestion of said data circuit has decreased (vacancy of said data circuit has increased) when said data reception time is decreasing, thereby transmitting the next data frame with increased image and sound qualities and/or an increased frame rate.

3. A data communications terminal for sequentially transferring frame data to and from another data communications terminal via a data circuit in units of data frames with each data frame amounting to one still picture containing compressed image data of variable length and compressed audio data of variable length, said data communications terminal characterized by data transmission functions capable of:
transmitting a multiplicity of leading data frames with predetermined image and sound qualities and/or a predetermined frame rate;
calculating a ratio (data reception time)/(data transmission time) from the data transmission time for said data communications terminal transmitting frame data to transmit respective data frames that precede the current data frame by at lease one data frame and the data reception time for the data communicatons terminal receiving frame data to receive respective data frames that precede the current data frame by at least one data frame;
determining the degree of congestion of said data circuit from said (data reception time)/(data transmission time);
making a determination that the degree of said data circuit has increased (vacancy of said data circuit has decreased) when said ratio (data reception time)/(data transmission time) is increasing, thereby transmitting the next data frame with reduced image and sound qualities and/or a reduced frame rate; and
making a determination that the degree of congestion of said data circuit has decreased (vacancy of said data circuit has increased) when said ratio (data reception time)/(data transmission time) is decreasing, thereby transmitting the next data frame with increased image and sound qualities and/or an increased frame rate.

4. The data communications terminal for sequentially transmitting to, and receiving from, another data communications terminal frame data via a data circuit in units of data frames with each data frame amounting to one still picture containing compressed image data of variable length and compressed audio data of variable length, according to any one of claims 1, 2, and 3, characterized in that the communications terminal receiving frame data has a data reception time measurement and data transmission function capable of measuring data reception time to receive respective data frames that are transmitted in sequence from a data communications terminal and transmitting said measured data reception time to the data transmitting terminal.

5. The data communications terminal according to claim 1 or claim 3, characterized in that said data transmission time is the time interval from the beginning of the transmission of data frame that precedes the current data frame by at least one frame and the end of said transmission by the data communications terminal transmitting frame data.

6. The data communications terminal according to any one of claims 2, 3, and 4, characterized in that said data reception time is the time interval from the beginning of the reception of data frame that precedes the current data frame by at least one frame and the end of said reception by the terminal receiving frame data.

7. The data communications terminal according to claims 1 or claim 5, characterized in that said data communications terminal is adapted to:
make a determination that the degree of congestion of said data circuit has increased (vacancy of said data circuit has decreased) when said data transmission time is increasing, thereby transmitting the next data frame with an increased data compression rate, a reduced picture size, and/or a reduced frame rate; and
make a determination that the degree of congestion of said data circuit has decreased (vacancy of said data circuit has increased) when said data transmission time is decreasing, thereby transmitting the next data frame with a reduced data compression rate, an increased picture size, and/or an increased frame rate.

8. The data communications terminal according to claim 2 or claim 6, wherein said data communications terminal is adapted to:
make a determination that the degree of congestion of said data circuit has increased (vacancy of said data circuit has decreased) when said data reception time is increasing, thereby transmitting the next data frame with an increased data compression rate, a reduced picture size, and/or a reduced frame rate; and
make a determination that the degree of congestion of said data circuit has decreased (vacancy of said data circuit has increased) when said data reception time is decreasing, thereby transmitting the next data frame with a reduced data compression rate, an increased picture size, and/or an increased frame rate.

9. The data communications terminal according to claims 3, characterized in that said data communications terminal is adapted to:
make a determination that the degree of congestion of said data circuit has increased (vacancy of said data circuit has decreased) when said ratio (data reception time)/(data transmission time) is increasing, thereby transmitting the next data frame with an increased data compression rate, a reduced picture size, and/or a reduced frame rate; and
make a determination that the degree of congestion of said data circuit has decreased (vacancy of said data circuit has increased) when said ratio (data reception time)/(data transmission time) is decreasing, thereby transmitting the next data frame with a reduced data compression rate, an increased picture size, and/or an increased frame rate.

10. The data communications terminal according to any one of claims 1, 2, and 3, characterized in that said data communications terminal prioritizes the sound quality over the frame rate of frame data to be transmitted when controlling the picture quality, sound quality and/or frame rate thereof in accordance with the degree of congestion of said data circuit.

11. The data communications terminal according to any one of claims 1, 2, and 3, characterized in that said data communications terminal is adapted to maintain a constant quality of said frame data to be transmitted such that, when reducing the picture and sound qualities and/or frame rate thereof, the picture and sound reproduced from said frame data are recognizable.

12. The data communications terminal according to any one of claims 1, 2, and 3, characterized in that said picture quality is given by the data compression rate and picture size (numbers of pixels in vertical and horizontal directions) of relevant picture data, and said sound quality is given by the data compression rate of relevant sound data.
